(19) United States
(12) Patent Application Publication
(10) Pub. No.: US 2011/0071898 A1
(43) Pub. Date: Mar. 24, 2011

(54) SYSTEM AND METHOD FOR UPDATING SEARCH ADVERTISEMENTS DURING SEARCH RESULTS NAVIGATION

(75) Inventors: Jun Feng, Fremont, CA (US); Jianbin Wei, Redwood City, CA (US)

(73) Assignee: Yahoo! Inc., Sunnyvale, CA (US)

(21) Appl. No.: 12/565,742

(22) Filed: Sep. 23, 2009

(51) Int. Cl. G06Q 30/00; G06F 17/30; G06F 7/10

(52) U.S. Cl. 705/14.43; 707/E17.109

(57) ABSTRACT

An improved system and method for updating search advertisements during search results navigation is provided. A search server may return search results from a search query with executable instructions that monitor events selecting a web page in the search results. When a web page may be selected in the search results on the client, a request that includes an address of a web page selected from the search results may be sent from the client to an advertiser server to update sponsored advertisements displayed in a sponsored advertisement area of the search results web page. The advertisement server may select an update of sponsored advertisements using query features, user features and web page features of the web page selected from the search results web page. The update may be sent to the client for display in the sponsored advertisement area of the search results web page.

### FIELD OF THE INVENTION

The invention relates generally to computer systems, and more particularly to an improved system and method for updating search advertisements during search results navigation.

### BACKGROUND OF THE INVENTION

Sponsored advertising is a widely used mechanism for selling advertisements using Internet search engines. Each time a user enters a search term into a search engine, advertising space may be allocated within that user's search results. For example, a sponsored search advertising area may be used for displaying sponsored advertisements on a search results web page. There are various methods for selling sponsored advertising in online search advertising including keyword auctions where keywords of a user's query may be auctioned to an advertiser who is the highest bidder with sufficient budget. Search engines' revenues from sponsored advertising are currently on the order of ten billion dollars per year.

When a user enters a search term into a search engine, the sponsored advertisements selected for display to the user are based on the initial search terms in the query submitted. Although a user has a search intention when conducting a search, it is often difficult to derive the user's search intention initially because of the limitations of current natural language processing. For example, when a user searches for the query, “chef's knife”, it is unclear whether the user is interested in purchasing a chef's knife or whether the user might be really looking for a local sharpening service for a particular brand of chef knives. The user's search intention cannot be directly inferred from the initial search keywords, so sponsored advertisements displayed with the initial search results may not be very relevant. Furthermore, a user could change the search intention during a search session. Unfortunately, this can make it difficult to directly infer the user's search intention.

What is needed is a way to provide advertisements that are more relevant to users' interest. Such a system and method should be able to discover the users' intent of the search query to provide more relevant advertisements.

### SUMMARY OF THE INVENTION

Briefly, the present invention may provide a system and method for updating search advertisements during search results navigation. In various embodiments, a client computer may be operably connected to a search server and an advertisement server. The client computer may include a sponsored advertisement update component operably coupled to a search result click event monitor that receives an address of a web page selectable from the search results web page. The sponsored advertisement update component may send a request that includes an address of a web page selected from a search results web page to update sponsored advertisements displayed in a sponsored advertisement area of the search results web page. In response to receiving a search query, a search server operably coupled to the client may add to a search results web page executable instructions for the search result click event monitor to receive an address of a web page selectable from the search results web page in order to send the click event to the advertisement server to update sponsored advertisements displayed in the sponsored advertisement area of the search results web page. The search server may also send a request with query features and user features to the advertisement server to serve a list of sponsored advertisements for display with the search results of query processing.

The advertisement server may be operably coupled to an advertisement serving engine that may include a sponsored advertisement selection engine that selects an update of sponsored advertisements using web page features of a web page selected from the search results web page in addition to using query features and user features. The advertisement serving engine may also include a sponsored advertisement scoring engine that scores candidates for the update of sponsored advertisements using query features, user features and web page features. The advertising serving engine may rank candidates for the update of sponsored advertisements in descending order by score and send a list of sponsored advertisement with the highest scores to the client computer for display in the sponsored advertisement area of the search results web page. Upon receiving the update of sponsored advertisements, the client computer may display the updated sponsored advertisements in the sponsored advertisement area of the search results web page.

In general, the present invention may effectively provide the capability for a user to receive updated sponsored advertisements displayed on a search results web page during navigation of search results from a search query. To do so, a web browser executing on a client computer may receive a search query input by a user and may send the search query request to a search server. In response, the search server may return search results with executable instructions that monitor events selecting an address of a web page in the search results web page to the web browser executing on the client. An address of a web page may be selected in the search results web page on the client, and a request that includes an address of a web page selected from a search results web page may be sent from the client computer to an advertiser server to update sponsored advertisements displayed in a sponsored advertisement area of the search results web page.

In response, the advertisement server may selects an update of sponsored advertisements using query features, user features and web page features of the web page selected from the search results web page. Candidate advertisements for the update of sponsored advertisements may be scored using query features, user features and web page features, and the candidate advertisements may be ranked in descending order by score. A list of sponsored advertisement with the highest scores may be send as an update to the client computer for display in the sponsored advertisement area of the search results web page. Upon receiving the update of sponsored advertisements, the client computer may display the updated sponsored advertisements in the sponsored advertisement area of the search results web page.

Advantageously, the present invention may effectively refine a user's search intention by tracking the user's interaction with search results and may deliver more personalized search advertisements to a user during navigation of search results. After receiving search results, more relevant advertisements may be selected by refining query features using web page features identified from navigation of search results. Updated search advertisements may be generated and displayed for a user to view. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for updating search advertisements during search results navigation, in accordance with an aspect of the present invention;

FIG. 3 is an illustration depicting in an embodiment a search results page with sponsored advertisements displayed by a web browser executing on a client device, in accordance with an aspect of the present invention;

FIG. 4 is a flowchart generally representing the steps undertaken in one embodiment for updating search advertisements during search results navigation, in accordance with an aspect of the present invention;

FIG. 5 is a flowchart generally representing the steps undertaken in one embodiment on a client for updating search advertisements during search results navigation, in accordance with an aspect of the present invention;

FIG. 6 is a flowchart generally representing the steps undertaken in one embodiment on a search server for updating search advertisements during search results navigation, in accordance with an aspect of the present invention; and

FIG. 7 is a flowchart generally representing the steps undertaken in one embodiment on an advertisement server for updating search advertisements during search results navigation, in accordance with an aspect of the present invention.

### DETAILED DESCRIPTION

### Exemplary Operating Environment

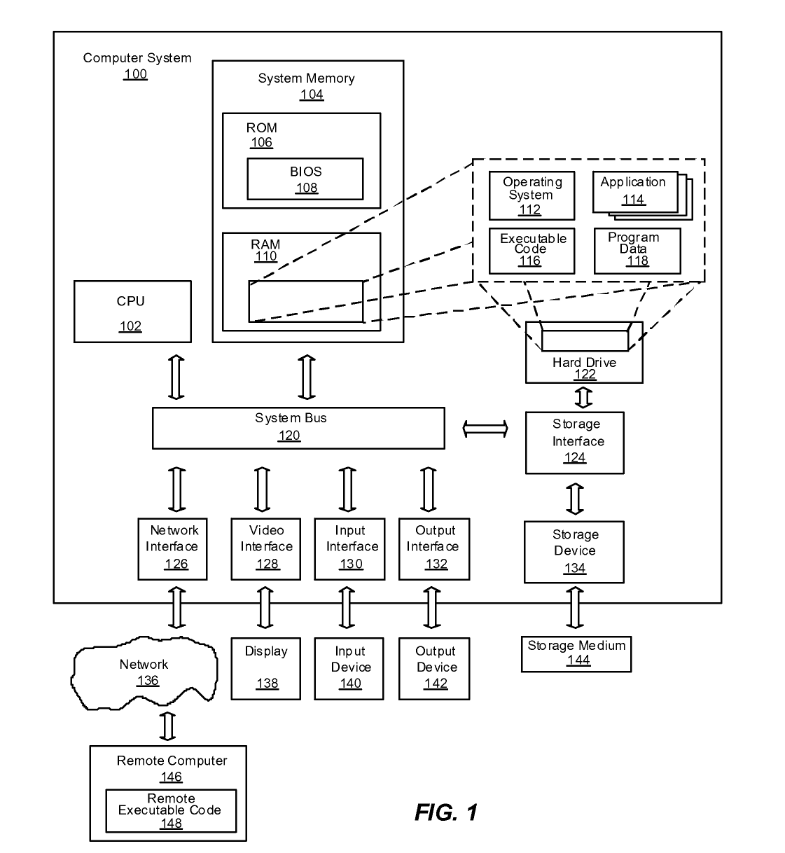

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Updating Search Advertisements During Search Results Navigation

The present invention is generally directed towards a system and method for updating search advertisements during search results navigation. In general, the present invention may provide the capability for a user to receive updated sponsored advertisements displayed on a search results web page during navigation of search results from a search query. When a web browser executing on a client computer may send a search query input by a user to a search server, the search server may return search results with executable instructions that monitor events selecting an address of a web page in the search results web page to the web browser executing on the client. A user may select a web page in search results, and the client computer may send a request to an advertiser server to update sponsored advertisements displayed in a sponsored advertisement area of the search results web page. In response, the advertisement server may selects an update of sponsored advertisements using query features, user features and web page features of the web page selected from the search results web page. The advertisement server may then send the update of sponsored advertisements to the client computer to display the updated sponsored advertisements in the sponsored advertisement area of the search results web page.

As will be seen, sponsored advertisements displayed in the sponsored advertisement area of a search results web page may be updated using features of selected web pages from search results that may signify the search intention of a user. As used herein, a sponsored advertisement means an advertisement that is promoted typically by financial consideration and includes auctioned advertisements display on a search results web page. As will be understood, the various block diagrams, flow charts and scenarios described herein are only examples, and there are many other scenarios to which the present invention will apply.

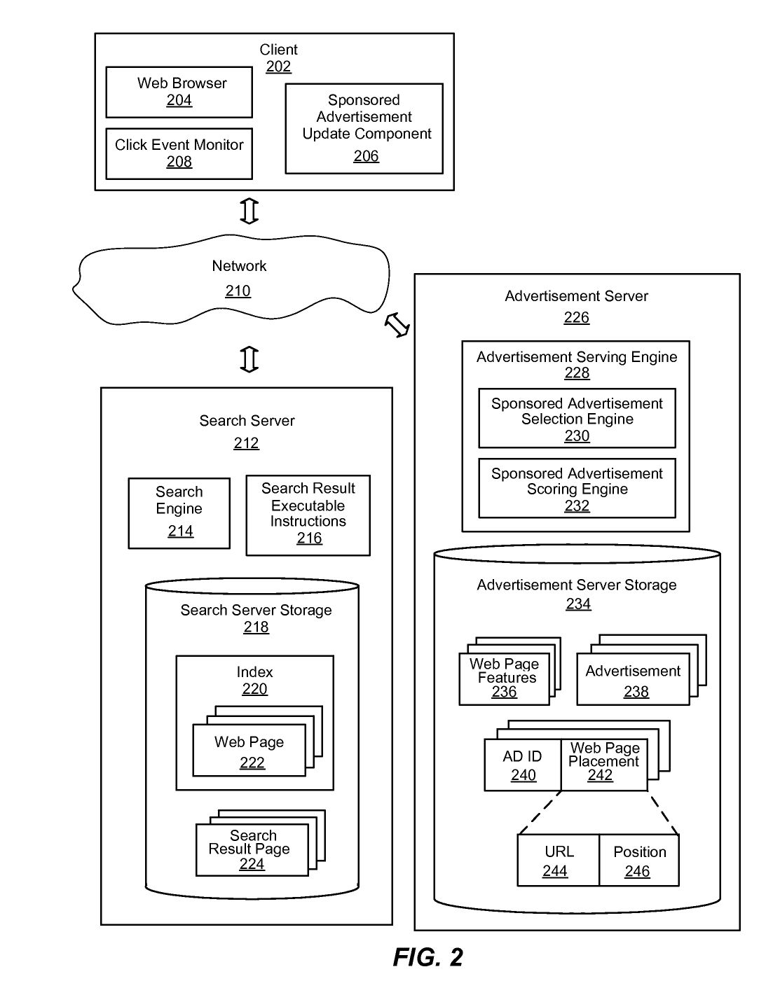

Turning to FIG. 2 of the drawings, there is shown a block diagram generally representing an exemplary architecture of system components for updating search advertisements during search results navigation. Those skilled in the art will appreciate that the functionality implemented within the blocks illustrated in the diagram may be implemented as separate components or the functionality of several or all of the blocks may be implemented within a single component. For example, the functionality for the sponsored advertisement scoring engine 232 may be included in the same component as the sponsored advertisement selection engine 230. Or the functionality of the sponsored advertisement scoring engine 232 may be implemented as a separate component from the sponsored advertisement selection engine 230 as shown. Moreover, those skilled in the art will appreciate that the functionality implemented within the blocks illustrated in the diagram may be executed on a single computer or distributed across a plurality of computers for execution.

In various embodiments, a client computer 202 may be operably coupled to a search server 212 and an advertisement server 226 by a network 210. The client computer 202 may be a computer such as computer system 100 of FIG. 1. The network 210 may be any type of network such as a local area network (LAN), a wide area network (WAN), or other type of network. A web browser 204 may execute on the client computer 202 and may include functionality for receiving a search request which may be input by a user entering a query and functionality for sending the query request to a server to obtain a list of search results. The web browser 204 may be operably coupled to a sponsored advertisement update component 206 that may include functionality for receiving a request from the web browser for updating one or more sponsored advertisements displayed in a sponsored advertisement area of a search results web page. The web browser 206 may also be operably coupled to a sponsored search click event monitor 208 that receives click events that request a URL in the search results from processing a search query and sends the click event to an advertiser server for refreshing a list of sponsored advertisements displayed in a sponsored advertisement area on a search results page. The web browser 204, the sponsored advertisement update component 206 and the search click event monitor 208 may also be any type of interpreted or executable software code such as a kernel component, an application program, a script, a linked library, an object with methods, and so forth.

The search server 212 may be any type of computer system or computing device such as computer system 100 of FIG. 1. In general, the search server 212 may provide services for processing a search query and may include services for requesting a list of sponsored advertisements from an advertisement server 226 to be sent to the web browser 204 executing on the client 202 for display with the search results of query processing. In particular, the search server 212 may include a search engine 214 for receiving and responding to search query requests, and the search server 212 may also include search result executable instructions 216 for the search result click event monitor 208 to receive click events that request a URL in the search results from processing a search query and to send the click event to an advertiser server for refreshing a list of sponsored advertisements displayed in a sponsored advertisement area on a search results page. Each of these components may also be any type of executable software code such as a kernel component, an application program, a linked library, an object with methods, a script or other type of executable software code. The search server 212 may be operably coupled to search server storage 218 that may store an index 220 of crawled web pages 222 that may be searched using keywords of the search query to find web pages that may be provided in the search results. The web page storage may also store search result web pages 224 that provide a list of search results with addresses of web pages such as Uniform Resource Locators (URLs).

The advertisement server 226 may be any type of computer system or computing device such as computer system 100 of FIG. 1. The advertisement server 226 may provide services for providing a list of advertisements that may be sent to the web browser 204 executing on the client 202 for display with the search results of query processing. The advertisement server 226 may include an advertisement serving engine 228 that may receive a request with query features and user features to serve a list of advertisements for display with the search results of query processing. The advertisement serving engine 228 may also receive a request with a click event to serve a refreshed list of advertisement for display with search results displayed on a search results page on the client 202. The advertisement serving engine 228 may include a sponsored advertisement selection engine 230 that may select the list of advertisements and may include functionality to select the list of advertisments using query features and user features; and, in the case of refreshing a list of advertisement for display with search results displayed on the search results page on the client, the sponsored advertisement selection engine 230 may include functionality to select the list of advertisements using web page features in addition to using query features and user features. The advertisement serving engine 228 may also include a sponsored advertisement scoring engine 232 that may score a list of advertisements using the query features and user features; and, in the case of refreshing a list of advertisements for display with search results displayed on the search results page on the client, the sponsored advertisement scoring engine 232 may also score a list of advertisements using web page features. The advertisement server 226 may be operably coupled to a database of advertisements such as advertisement server storage 234 that may include any type of advertisements 238 that may be associated with an advertisement ID 240. In an embodiment, an advertisement 238 may be displayed according to a web page placement 242. An advertisement ID 240 associated with an advertisement 238 may be allocated to a web page placement 242 that may include a Uniform Resource Locator (URL) 244 for a web page and a position 246 for displaying an advertisement on the web page. In various embodiments, a web page may be any information that may be addressable by a URL, including a document, an image, audio, and so forth. As used herein, a web page placement may mean a location on a web page designated for placing an advertisement for display.

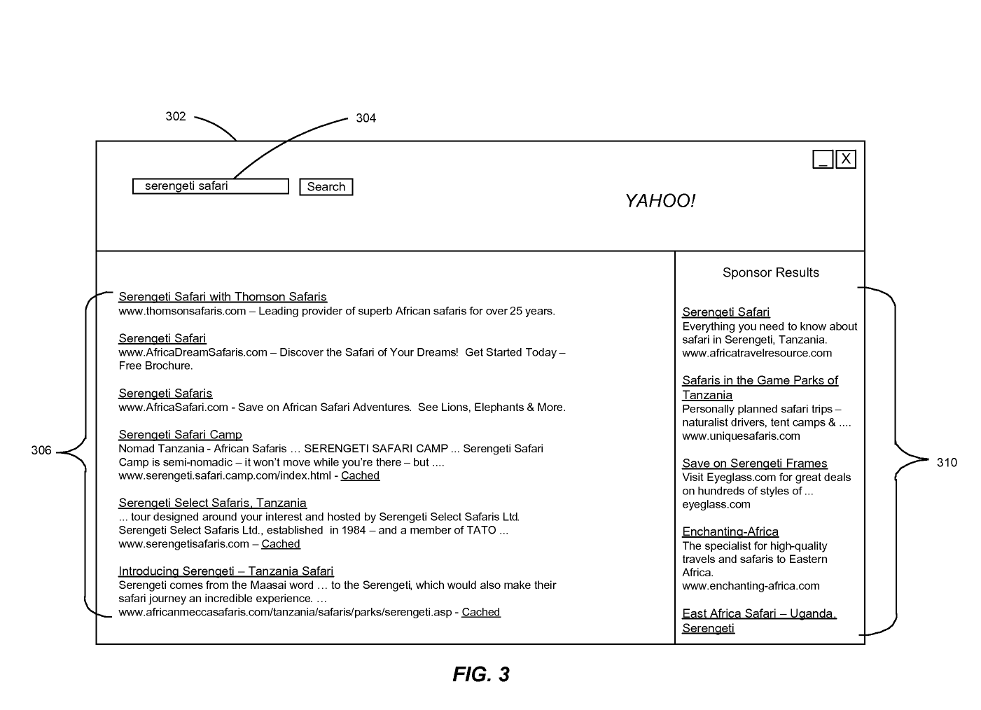

When a user may select a URL displayed in a search results page to request content of a web page, the present invention may send a click event with the URL of the web page selected to an advertisement server that may use features of the web page along with query features and user features to update a list of sponsored advertisements displayed on the search results page. For example, FIG. 3 depicts in an embodiment a search results page with sponsored advertisements displayed by a web browser running on a client device. A display of a web browser 302 is illustrated in FIG. 3 for a search results page and may include a text input field 304 so a user may enter a search query such as “serengeti safari”. In the embodiment illustrated in FIG. 3 for example, search results such as the list of URLS with descriptive text 306 may be displayed in one area of the search results page and the search results may also include sponsored search advertisements as shown. There may also be sponsored search advertisements such as the list of sponsored search advertisements 310 displayed in another area of the search results page dedicated for sponsored search advertisements such as the area depicted with sponsor results. A user may select a URL displayed in a search results page to request content of a web page, and a click event with the URL of the web page selected may be sent to an advertisement server that may use features of the web page along with query features and user features to update a list of sponsored advertisements displayed on the search results page. The updated list of sponsored advertisements may be sent to the client device for display in the sponsored search advertisements area of the search results page.

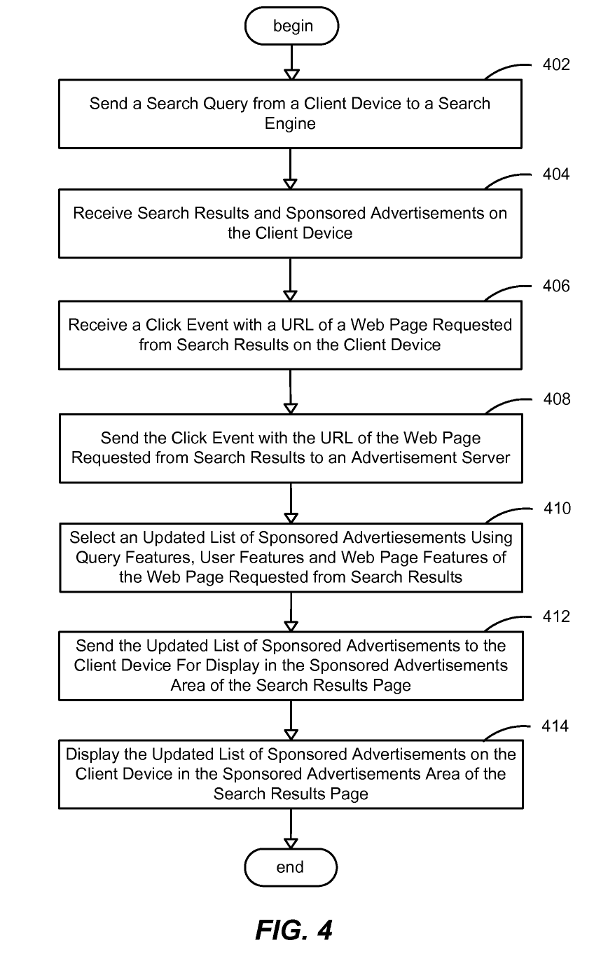

FIG. 4 presents a flowchart generally representing the steps undertaken in one embodiment for updating search advertisements during search results navigation. At step 402, a search query may be sent by a client device to a search engine to obtain search results. At step 404, search results may be received by the client device from a search engine, such as search engine 214, and sponsored advertisements may be received by the client device from an advertisement serving engine, such as advertisement serving engine 228. A user may select a URL displayed in a search results page to request content of a web page, and as a result, a click event with the URL of a web page requested from search results may be received at step 406 by the client device. At step 408, the click event with the URL of a web page requested from search results may be sent by the client device to an advertisement server.

The advertisement server may then select an updated list of sponsored advertisements at step 410 using query features, user features, and web page features of the web page requested from search results. In an embodiment, the query features may include the terms used in the search query, and the user features may include geographic attributes such as zip code, demographic attributes such as age and gender, and behavioral attributes associated with the user. The web page features may include unigrams and phrases of content of the web page, categories of the web page, geographic attributes of the web page, and so forth. At step 412, an updated list of sponsored advertisements may then be sent from the advertisement server to the client device for display in the sponsored advertisement area of the search results web page. And the updated list of sponsored advertisements may then be displayed in the sponsored advertisement area of the search results page at step 414.

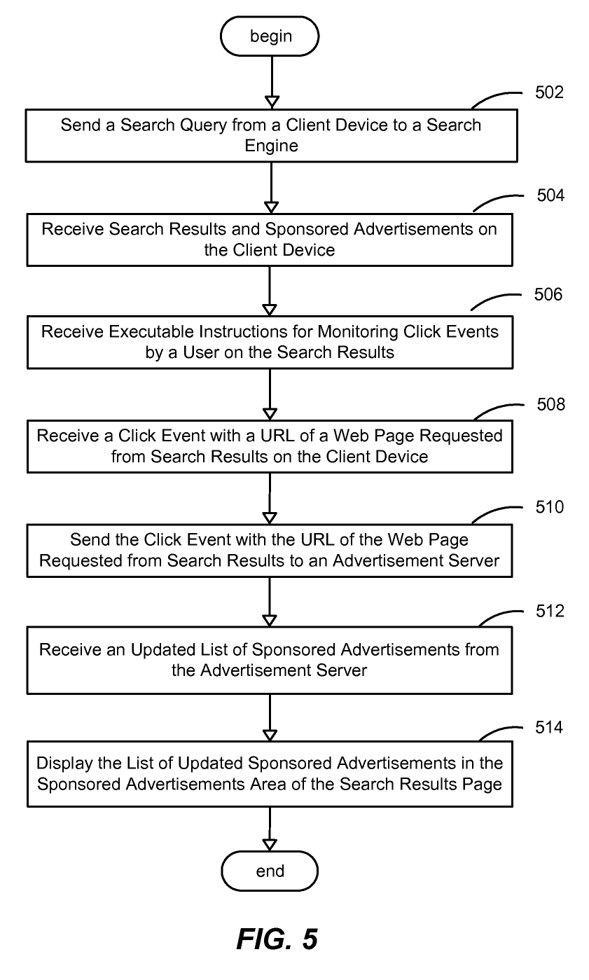

FIG. 5 presents a flowchart generally representing the steps undertaken in one embodiment on a client for updating search advertisements during search results navigation. At step 502, a search query may be sent by a client to a search engine, and search results and sponsored advertisements may be received at step 504 by the client device. In addition, executable instructions for monitoring click events by a user to select a search result may be received at step 506. In an embodiment, the executable instructions may be a script, such as JavaScript, that is added to an HML (Hypertext Markup Language) or an XML (Extensible Markup Language) document that encodes the search results page.

A user may select a URL displayed on a search results page to request content of a web page, and as a result, a click event with the URL of a web page requested from search results may be received at step 508 by the client device. In an embodiment, a click event monitor 208 with the executable instructions for monitoring click events by a user to select search results may receive the click event. At step 510, the click event with the URL of a web page requested from search results may be sent by the client device to an advertisement server which may send an updated list of sponsored advertisements for display in the sponsored advertisement area of the search results page. An updated list of sponsored advertisements from the advertisement server may then be received at step 512 by the client device. And the client device may display the updated list of sponsored advertisements in the sponsored advertisement area of the search results web page at step 514. Those skilled in the art will appreciate that while the advertisement server may select an updated list of sponsored advertisements, the web browser executing on the client device may send a request to fetch the web page, and, when the web page is received, the web browser may open a new window on the client device in an embodiment to display the content of the web page requested from search results.

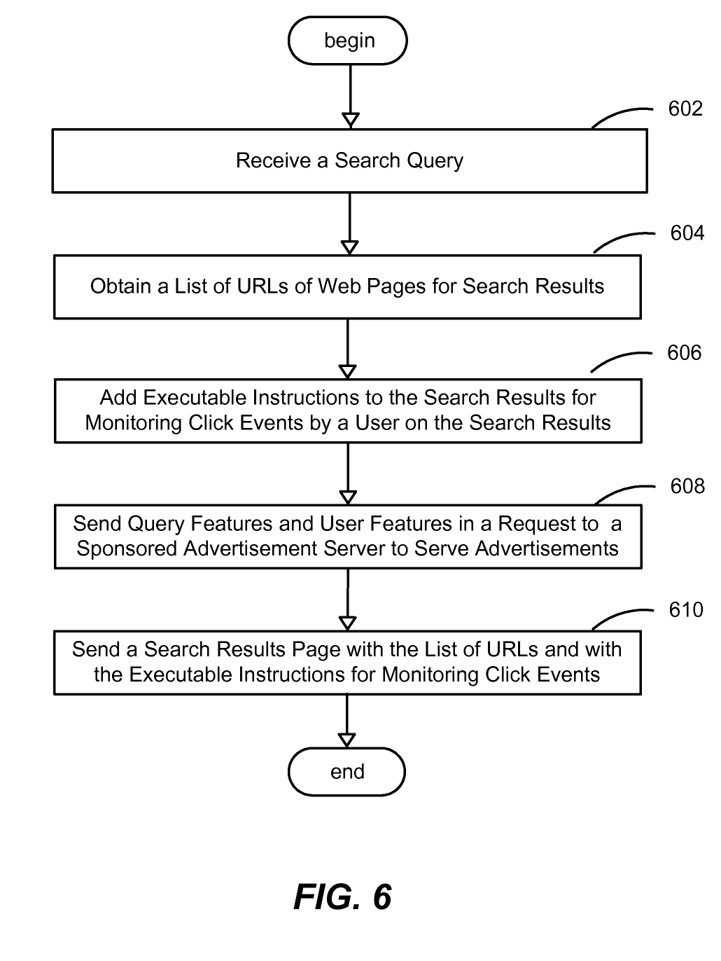

FIG. 6 presents a flowchart generally representing the steps undertaken in one embodiment on a search server for updating search advertisements during search results navigation. At step 602, a search query from a client may be received by the search server. In response, a list of URLs of web pages may be obtained for search results at step 604. At step 606, a search results page may be constructed with the list of URLs of web pages, and executable instructions that monitor click events by a user to select a URL from the search results may be added to the search results page. In an embodiment, the executable instructions may be a script, such as JavaScript, that is added to an encoding of a document that represents the search results page. At step 608, a search server may send to an advertisement server query features and user features in a request to send sponsored advertisements to a web browser for display in the sponsored advertisement area of the search results page. And a search results page with a list of URLs of web pages and with executable instructions for monitoring click events may be sent to a client device at step 610.

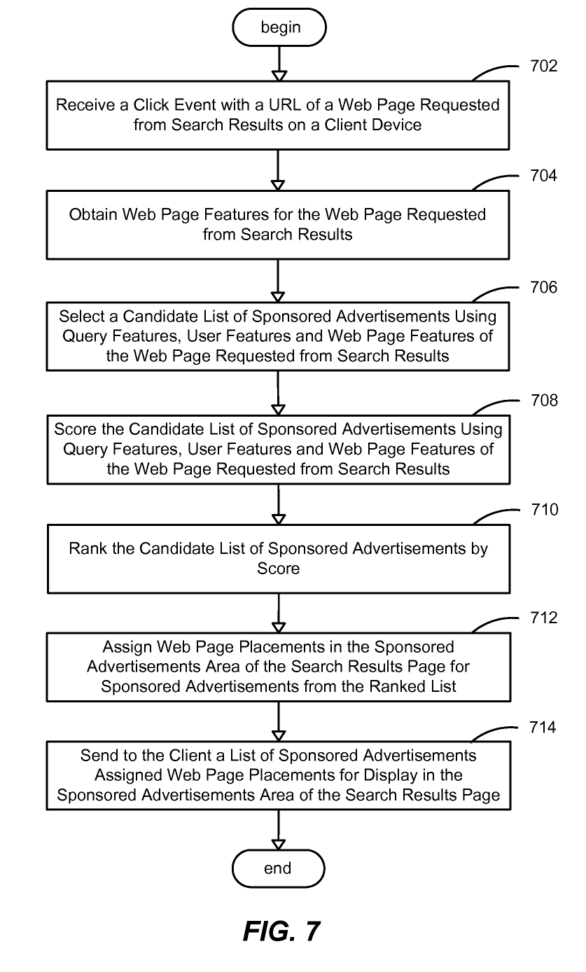

FIG. 7 presents a flowchart generally representing the steps undertaken in one embodiment on an advertisement server for updating search advertisements during search results navigation. At step 702, a click event with the URL of a web page requested from search results on a client device may be received by an advertisement server. The advertisement server may obtain web page features at step 704 for the web page requested from search results. In an embodiment, the web page features may be retrieved from an index of web pages that includes web page features in storage on a search server.

The advertisement server may then select a candidate list of sponsored advertisements at step 706 using query features, user features, and web page features of the web page requested from search results. In an embodiment, a sponsored advertisement selection engine may fetch the posting listing for these query features from an advertisement index. And the advertisement server may score the candidate list of sponsored advertisements at step 708 using query features, user features, and web page features of the web page requested from search results. In an embodiment, a sponsored advertisement scoring engine may score the candidate list of sponsored advertisements based on the vector distance between features. For instance, a user, a web page and advertisements may be each represented by several vectors in different spaces. Each vector space may represent a type of feature, such as unigrams, phrases, categories, and so forth. Each dimension of the vector may capture the intensity of that feature. For instance, a web page may have a vector of unigrams, and each dimension of that vector is a frequency value associated with a word. Thus, for each advertisement in the database, the scorer may calculate the distance of the advertisement's vectors from the vectors of the user and web page for each vector space such as unigrams, phrases, and so forth. Then the scorer will calculate a final score, which represents a linear combination of the individual distances between vector spaces of the advertisement and the user and web page. In an embodiment, the distance may be calculated by cosine similarity.

At step 710, the candidate list of sponsored advertisements may be ranked by score. And sponsored advertisement from the ranked list may be assigned web page placements in the sponsored advertisements area of the search results page at step 712. In an embodiment, the highest scoring sponsored advertisements from the ranked list of sponsored advertisements are assigned to the available web page placements in order by highest score. And the list of sponsored advertisements assigned web page placements for display in the sponsored advertisements area of the search results page may be sent to a client device at step 714.

Those skilled in the art will appreciate that other scoring techniques may be used. For instance, a scorer can take into consideration the probability of a user click on an advertisement. In this case, the score may represent the probability of a user click on an advertisement if it is served for display in the sponsored advertisement area of the search results page. For such a scorer, the probability database may be initialized during a training phase, and advertisement impressions and user clicks from the traffic event streams may be provided to the scorer for updating the probability database. In various embodiments, vector distance based scoring and probability based scoring may be used together.

Thus the present invention may effectively refine a user's search intention by tracking the user's interaction with search results and may deliver more personalized search advertisements to a user during navigation of search results. After receiving search results, more relevant advertisements may be selected by refining query features using web page features identified from navigation of search results. While the advertisement server may select an updated list of sponsored advertisements, the web browser executing on the client device may send a request to fetch the web page, and, when the web page is received, the web browser may open a new window on the client device in an embodiment to display the content of the web page requested from search results. And updated search advertisements may be sent to a client device and displayed for a user to view in the sponsored advertisements area of the search results page.

As can be seen from the foregoing detailed description, the present invention provides an improved system and method for updating search advertisements during search results navigation. A search server may return search results from a search query with executable instructions that monitor events selecting a web page in the search results. When a web page may be selected in the search results on the client, a request that includes an address of a web page selected from the search results may be sent from the client to an advertiser server to update sponsored advertisements displayed in a sponsored advertisement area of the search results web page. The advertisement server may select an update of sponsored advertisements using query features, user features and web page features of the web page selected from the search results web page. The update may be sent to the client for display in the sponsored advertisement area of the search results web page. As a result, the system and method provide significant advantages and benefits needed in contemporary computing and in search advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for updating search advertisements, comprising:
a sponsored advertisement update component that sends a request that includes an address of a web page selected from a search results web page to update one or more sponsored advertisements displayed in a sponsored advertisement area of the search results web page;
a search result click event monitor operably coupled to the sponsored advertisement update component that receives the address of the web page selected from the search results web page to update the one or more sponsored advertisements displayed in the sponsored advertisement area of the search results web page; and
a storage with the search results web page operably coupled to the sponsored advertisement update component to store the search results web page operably coupled to the search result click event monitor that receives the address of the web page selected from the search results web page to update the one or more sponsored advertisements displayed in the sponsored advertisement area of the search results web page.

2. The system of claim 1 further comprising a sponsored advertisement selection engine operably coupled to the sponsored advertisement update component that selects a candidate list of a plurality of sponsored advertisements using at least one query feature and at least one web page feature of the web page selected from the search results web page to update the one or more sponsored advertisements displayed in the sponsored advertisement area of the search results web page.

3. The system of claim 1 further comprising a sponsored advertisement selection engine operably coupled to the sponsored advertisement update component that scores a plurality of sponsored advertisement from the candidate list of the plurality of sponsored advertisements using at least one query feature and at least one web page feature of the web page selected from the search results web page to update the one or more sponsored advertisements displayed in the sponsored advertisement area of the search results web page.

4. The system of claim 1 further comprising a web browser operably coupled to the sponsored advertisement update component that displays an updated list of sponsored advertisements in the sponsored advertisement area of the search results web page.

5. A computer-readable storage medium having computer-executable components comprising the system of claim 1.

6. A computer-implemented method for updating search advertisements, comprising:
receiving at least one feature of a web page selected from a search results web page to update one or more sponsored advertisements displayed in a sponsored advertisement area of the search results web page;
scoring a candidate list of a plurality of sponsored advertisements using at least one query feature and the at least one feature of the web page selected from the search results web page to update one or more sponsored advertisements displayed in the sponsored advertisement area of the search results web page;
assigning at least one sponsored advertisement from the candidate list of the plurality of sponsored advertisements with a high ranking score to at least one web page placement in the sponsored advertisements area of the search results web page; and
sending the at least one sponsored advertisement for display on the search results web page in a location of the at least one web page placement in the sponsored advertisement area of the search results web page.

7. The method of claim 6 further comprising storing the at least one sponsored advertisement for display on the search results web page in the location of the at least one web page placement in the sponsored advertisement area of the search results web page.

8. The method of claim 6 further comprising selecting the candidate list of the plurality of sponsored advertisements using the at least one query feature and the at least one feature of the web page selected from the search results web page to update one or more sponsored advertisements displayed in the sponsored advertisement area of the search results web page.

9. The method of claim 6 further comprising ranking the candidate list of the plurality of sponsored advertisements in order by a score calculated for each of the plurality of sponsored advertisements using the at least one query feature and the at least one feature of the web page selected from the search results web page.

10. The method of claim 6 further comprising receiving by a client device the search results web page and executable instructions to receive an address of the web page selected from the search results web page to update one or more sponsored advertisements displayed in the sponsored advertisement area of the search results web page.

11. The method of claim 6 further comprising receiving by a client device an event indicating an address of the web page selected from the search results web page.

12. The method of claim 6 further comprising sending by a client device an event indicating an address of the web page selected from the search results web page to update one or more sponsored advertisements displayed in the sponsored advertisement area of the search results web page.

13. The method of claim 6 further comprising receiving by a client device the at least one sponsored advertisement for display on the search results web page in the location of the at least one web page placement in the sponsored advertisement area of the search results web page.

14. The method of claim 6 further comprising displaying by a client device the at least one sponsored advertisement in the location of the at least one web page placement in the sponsored advertisement area of the search results web page.

15. The method of claim 6 further comprising adding by a search engine to the search results web page executable instructions that receive an address of the web page selected from the search results web page to update one or more sponsored advertisements displayed in the sponsored advertisement area of the search results web page.

16. The method of claim 6 further comprising sending by a search engine to a client device the search results web page and the executable instructions to receive the address of the web page selected from the search results web page to update one or more sponsored advertisements displayed in the sponsored advertisement area of the search results web page.

17. The method of claim 6 wherein scoring the candidate list of the plurality of sponsored advertisements using the at least one query feature and the at least one feature of the web page selected from the search results web page to update one or more sponsored advertisements displayed in the sponsored advertisement area of the search results web page comprises scoring the candidate list of the plurality of sponsored advertisements using at least one user feature.

18. A computer-readable storage medium having computer-executable instructions for performing the method of claim 6.

19. A computer system for updating search advertisements, comprising:
means for receiving by a client device a search results web page and executable instructions to receive an address of a web page selected from the search results web page to update one or more sponsored advertisements displayed in a sponsored advertisement area of the search results web page;
means for sending to an advertisement server the address of the web page selected from the search results web page to update one or more sponsored advertisements displayed in the sponsored advertisement area of the search results web page;
means for using at least one query feature and at least one feature of the web page selected from the search results web page by the advertisement server to update the one or more sponsored advertisements displayed in the sponsored advertisement area of the search results web page; and
means for displaying by the client device an update of the one or more sponsored advertisements displayed in the sponsored advertisement area of the search results web page.

20. The computer system of claim 19 further comprising means for sending to the advertisement server the at least one query feature and at least one user feature to update the one or more sponsored advertisements displayed in the sponsored advertisement area of the search results web page.
